(19) United States
(12) Patent Application Publication
(10) Pub. No.: US 2005/0161297 A1
(43) Pub. Date: Jul. 28, 2005

(54) Brake pad backing plate and method of making the same

(75) Inventor: Munir Uwaydah, Santa Monica, CA (US)

Correspondence Address: HENRICKS SLAVIN AND HOLMES LLP;SUITE 200, 840 APOLLO STREET, EL SEGUNDO, CA, 90245, US

(73) Assignee: Innovative Technologies, LLC

(21) Appl. No.: 10/763,607

(22) Filed: Jan. 23, 2004

(51) Int. Cl. F16D 65/04

(52) U.S. Cl. 188/250 B

(57) ABSTRACT

Brake pads, brake pad backing plates and methods of producing the same.

### BACKGROUND OF THE INVENTIONS

1. Field of Inventions

The present inventions relate generally to brake pads and brake pad backing plates.

2. Description of the Related Art

Brakes, which are used to control the speed of a wide variety of vehicles, commonly include a brake pad that engages a rotor. The brake pads consist of friction pad and a backing plate that is used to mount the brake pad on the brake. The backing plate/friction pad connection must be very secure because of the high levels of shear and tensile forces that are applied to the friction pad by the rotor, vehicle vibrations, etc. Some conventional methods of securing the friction pad to the backing plate involve molding the friction pad onto the backing plate. Frequently, discontinuities are formed on the surface of the backing plate in order to increase the surface area of the backing plate/friction pad bond and to create mechanical interference between the two.

The present inventor has determined that conventional methods of securing the friction pad to the backing plate, including the formation of the the backing plate itself, are susceptible to improvement. For example, the present inventor has determined that the conventional method of forming discontinuities on the backing plate, i.e. forming the discontinuities by punching or gouging the backing plate after the backing plate has been stamped out of a sheet of metal, is unnecessarily difficult and expensive. The present inventor has also determined that the configuration of the protrusions or other discontinuities on conventional backing plates is susceptible to improvement.

### SUMMARY OF THE INVENTIONS

A method in accordance with a present invention involves cutting a brake pad backing plate out of a sheet having a plurality of discontinuities formed therein. A brake pad may be manufactured by subsequently securing a friction pad to the brake pad backing plate. There are a number of cost saving advantages associated with such a method. For example, it is much easier to form discontinuities in a large sheet and then form brake pads from the sheet than it is to form brake pads from and sheet with no discontinuities and then form discontinuities in each of the brake pads individually. Additionally, the discontinuities may be formed during the sheet formation process for further cost savings.

A brake pad backing plate in accordance with a present invention includes protrusions with a slanted parallelepiped shape. Such protrusions increase the bonding surface area of the backing plate and provide overhangs which act as hooks to mechanically engage the friction pad after bonding.

The above described and many other features and attendant advantages of the present inventions will become apparent as the inventions become better understood by reference to the following detailed description when considered in conjunction with the accompanying drawings.

### BRIEF DESCRIPTION OF THE DRAWINGS

Detailed description of embodiments of the inventions will be made with reference to the accompanying drawings.

FIG. 1 is a plan view of a brake pad backing plate in accordance with an embodiment of a present invention.

FIG. 2 is an enlarged perspective view of a portion of the brake pad backing plate illustrated in FIG. 1.

FIG. 3 is a section view taken along line 3-3 in FIG. 1.

FIG. 4 is a section view taken along line 4-4 in FIG. 1.

FIG. 5 is a section view taken along line 5-5 in FIG. 1.

FIG. 6 is a rear view of the brake pad backing plate illustrated in FIG. 1.

FIG. 7 is a plan view of a brake pad in accordance with an embodiment of a present invention.

FIG. 8 is a section view taken along line 8-8 in FIG. 7.

FIG. 9 is an enlarged perspective view of a portion of the brake pad illustrated in FIG. 7.

FIG. 10 is a side view of a metal slab for use in methods in accordance with a present invention.

FIGS. 11A-C are side views of steps in a method in accordance with an embodiment of a present invention.

FIG. 12A is a front view of a die for use in a method in accordance with one embodiment of a present invention.

FIGS. 12B and 12C are side and plan views of a step in a method in accordance with one embodiment of a present invention.

FIG. 12D is a front view of a die for use in a method in accordance with one embodiment of a present invention.

FIGS. 12E and 12F are side and plan views of a step in a method in accordance with one embodiment of a present invention.

FIG. 13A is a side view of a step in a method in accordance with one embodiment of a present invention.

FIG. 13B is a plan view of a backing plate sheet after backing plates have been stamped out of it.

### DETAILED DESCRIPTION OF THE ILLUSTRATE EMBODIMENTS

The following is a detailed description of the best presently known modes of carrying out the inventions. This description is not to be taken in a limiting sense, but is made merely for the purpose of illustrating the general principles of the inventions.

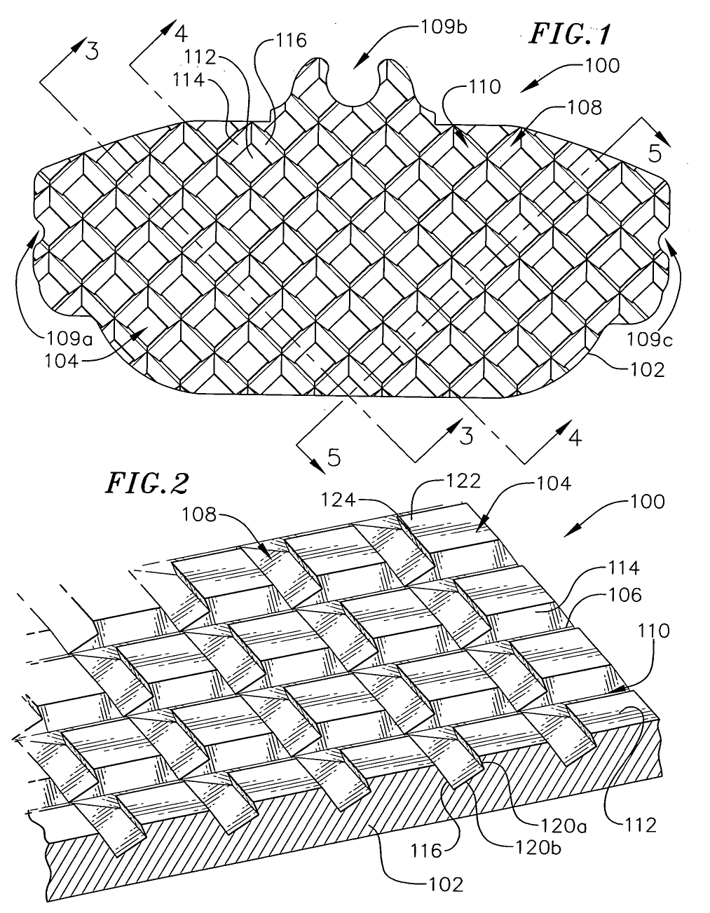

As illustrated for example in FIGS. 1 and 2, a brake pad backing plate 100 in accordance with one embodiment of a present invention includes a plate member 102 and a plurality of protrusions 104 extending outwardly from the front side 106 of the backing plate. The protrusions 104 add to the overall bonding surface area of the backing plate 100. The rear side 107 of the backing plate is generally planar, as is the front side 106. The protrusions 104 are separated by a first set of parallel channels 108 (which extend down and to the left in FIG. 1) and a second set of parallel channels 110 (which extend down and to the right in FIG. 1). Although the present inventions are not limited to any particular configuration, the exemplary channels 108 and 110 are substantially identical and cross one another to define the protrusions 104. The exemplary backing plate 100 may also be provided with mounting notches 109a-c, which are used to mount the backing plate in place in the caliper, in some implementations of the inventions.

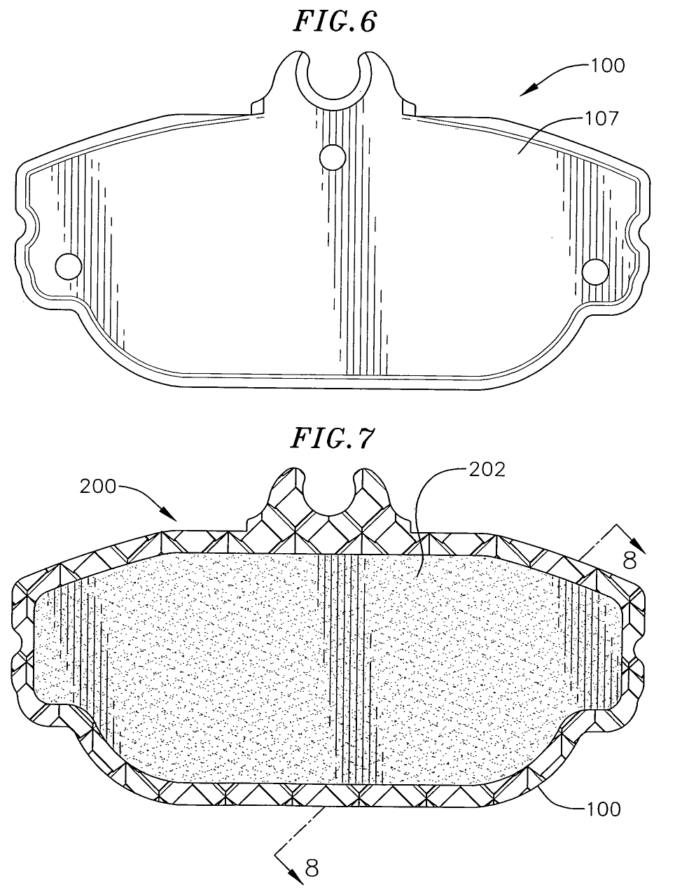

The protrusions 104, which are also substantially identical to one another in the exemplary implementation, each include a planar top surface 112 and four (4) side surfaces 114-120 (FIGS. 2-5). The side surfaces 114 and 116 are generally planar and continuous, while the side surface 118 includes planar portions 118a/118b that are arranged at an angle to one another and side surface 120 includes planar portions 120a/120b that are arranged at an angle to one another. The planar portion 118a of the side surface 118 is parallel to side surface 114, and the planar portion 120a of the side surface 120 is parallel to side surface 116. The planar portion 118b of the side surface 118 defines angles α₁ and β₁, respectively, with the side surface 114 and the planar portion 118a. The planar portion 120b of the side surface 120 define angles α₂ and β₂, respectively, with the side surface 116 and the planar portion 120a. Additionally, the side surface planar portions 118a and 120a are not perpendicular to the top surface 112 and, instead, slope inwardly and define obtuse angles θ₁ and θ₂ with the plane defined by the protrusion top surfaces 112. The inward slope of the planar portions 118a and 120a creates overhangs 122 and 124 which prevent the friction pad from being pulled off of the backing plate 100. More specifically, the overhangs 122 and 124 act as hooks and engage the friction pad in the manner described in greater detail below with reference to FIGS. 7-9.

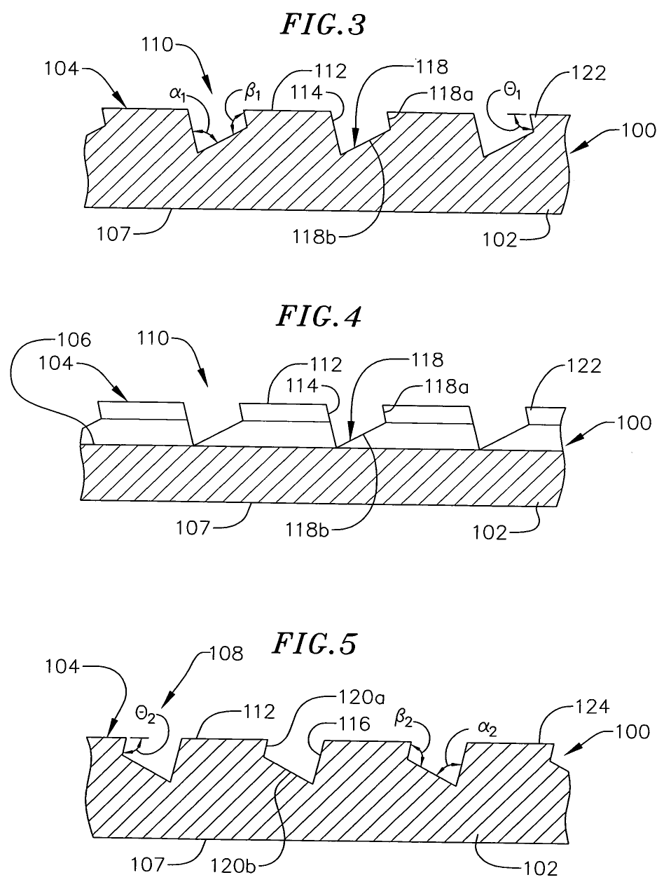

In some embodiments of the present brake pad backing plate, at least a portion of the backing plate protrusions will have a slanted, parallelepiped shape. The exemplary protrusions 104, for example, are configured such that the portion of the protrusion between the top surface 112 and the plane defined by the line at the intersection of the side surface planar portions 118a/118b and the line at the intersection of the side surface planar portions 120a/120b has a slanted parallelepiped shape. [Note FIGS. 3 and 5.] The parallelepiped portion slants in two directions, thereby defining the overhangs 122 and 124. Alternatively, in those implementations where a slanted parallelepiped shape is employed, the side surface planar portions 118b and 120b may be oriented such that they are parallel to the top surface 112 of the each protrusion 104 so that the entire protrusion defines the slanted parallelepiped shape.

With respect to materials and dimensions, the overall size of the brake pad backing plate 100 will depend on the intended application, as will the size and shape of the protrusions, the angles discussed above, and the material from which the backing plate is formed. In one exemplary implementation, which may be used in automotive applications, suitable materials include metals (such as 1010 steel), organics, ceramics, metal composites, plastics and high temperature fiber reinforced resin composites. The brake pad backing plate 100 will be about 2 to 15 inches wide (about 4.9 inches in one specific embodiment) and about 1 to 6 inches tall (about 2.6 inches in one specific embodiment), measured at the widest and tallest points. The thickness will be about 0.150 and 0.400 inches (and about 0.26 inches in one specific embodiment), measured from the top surfaces 112 of the protrusions 104 to the rear side 107. The protrusions 104 are about 0.04 to 0.12 inches high measured from the front side of the base member 102 to the top surfaces 112. The top surfaces 112 of the exemplary protrusions are square and are about 0.24 to about 0.26 inches in length and width. The distance between adjacent top surfaces 112 is about 0.04 to 0.12 inches. The angles α₁ and α₂ are preferably, but not necessarily, equal and about 30° to about 60°, the angles β₁ and β₂ are preferably, but not necessarily, equal and about 120° to about 150°, and the angles θ₁ and θ₂ are preferably, but not necessarily, equal and about 120° to about 150°. The dimensions above may, of course, be increased and decreased as applications so require.

There are, of course, an almost endless variety of alternative configurations. For example, the protrusions 104 my be made either larger or smaller (both in height and, when viewed in plan, surface area), the angles may be varied, the shape of the top surfaces 112 may be other than square (such as triangular or rectangular), the size and shape of the protrusions may be varied over the backing plate 100, and the distances between adjacent protrusions may be varied. The orientation of the protrusions 104 (i.e. the direction that the overhangs 122 and 124 face) may be adjusted as necessary. Additionally, the overall shape of the backing plate 100 could be curved instead of planar.

Turning to the channels 108 and 110, and given the shapes of the side surfaces 114-120, the channels are each generally defined by three planar walls, with gaps in the planar walls between the protrusions 104. The channels 108 and 110 could, alternatively, be formed with additional planar walls by, for example, splitting the planar portions 118b and 120b into two planar portions arranged at an angle to one another. The channels 108 and 110 could also have a continuous curved shape with two planar portions such as, for example the shape of a “U” that is oriented with the vertical portions angled in a manner similar to the side surfaces 114 and 116 and side surface planar portions 118a and 120a.

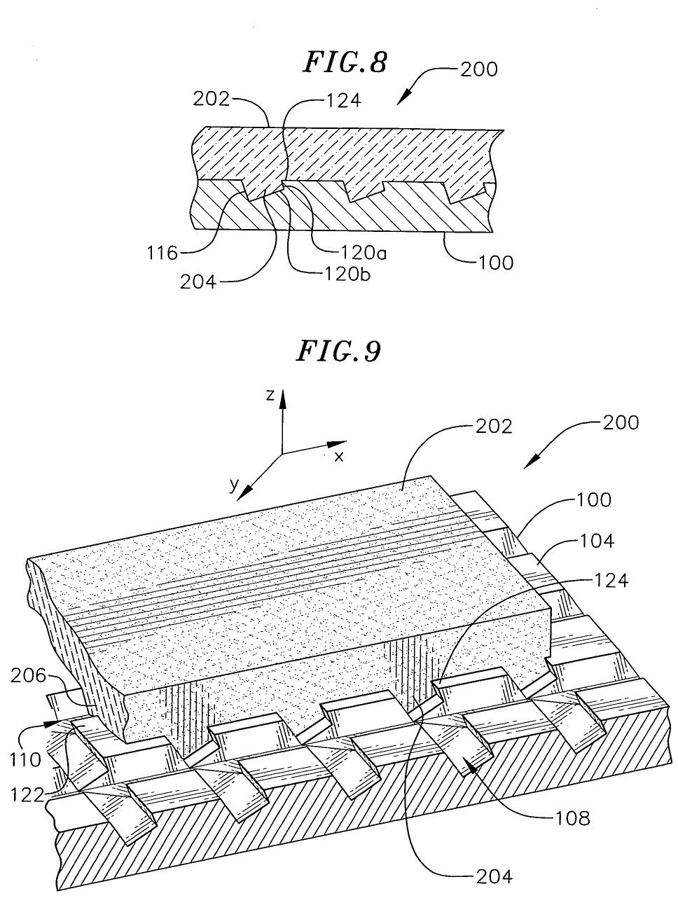

As illustrated for example in FIG. 7, a brake pad 200 in accordance with one embodiment of a present invention includes the backing plate 100 and a friction pad 202. The exemplary friction pad 202, which preferably covers a substantial portion of the backing plate 100, may be molded onto the backing plate in conventional fashion. Suitable materials include conventional friction pad materials such as metallic and organic compounds. Turning to FIGS. 8 and 9, some of the friction pad material (identified by reference numerals 204 and 206) will fill the portions of the channels 108 and 110 within the outer perimeter of the friction pad 202. This creates a mechanical interference/interlock between the protrusions 104 and the friction pad 202 that prevents the friction pad from moving in the X, Y or Z-direction. With respect to the Z-direction, the overhangs 122 and 124 act like hooks to grab the friction pad material. Moreover, because the overhangs 122 and 124 face in different directions (i.e. directions that are perpendicular to one another in the exemplary embodiment), there will be a mechanical interference even when the friction pad 202 is pulled in a direction that is parallel to the side wall planar portion 118a or a direction that is parallel to the side wall planar portion 120a.

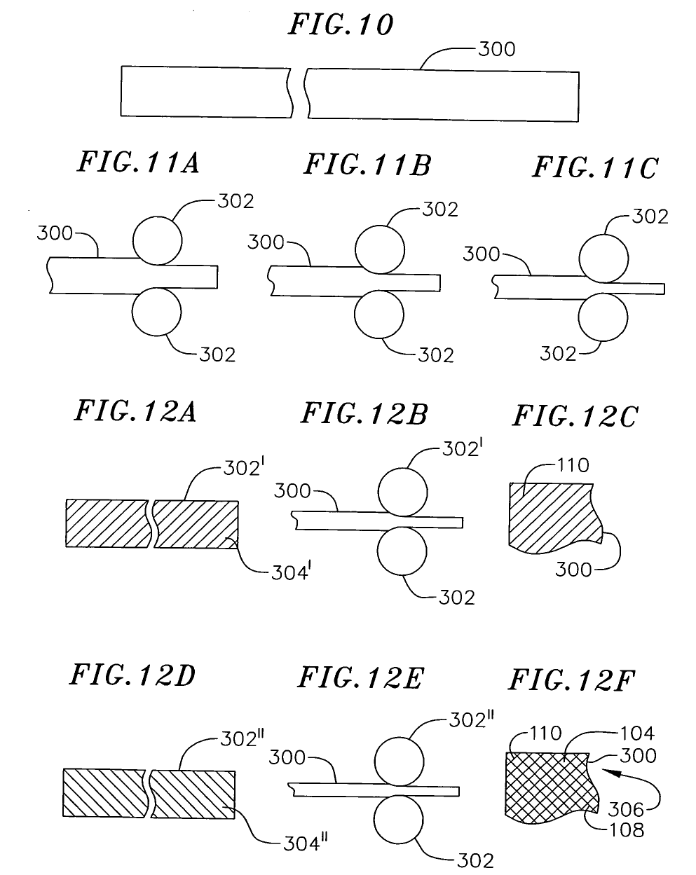

The exemplary brake pad backing plate 100 may be manufactured in a variety of ways. One example of a manufacturing method in accordance with a present invention, which is well suited for metal backing plates, is illustrated in FIG. 10-13. The present process generally involves forming a backing plate sheet with the discontinuities formed therein (such as for example, the exemplary protrusions 104 and channels 108 and 110 illustrated in FIGS. 1-5), and stamping individual brake pad backing plates 100 out of the sheet after the discontinuities have been formed.

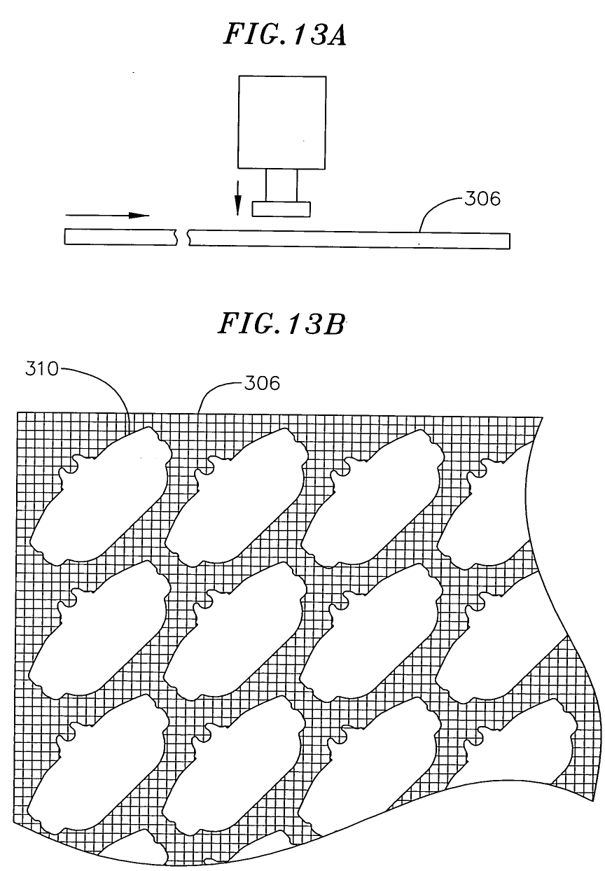

Referring first to FIGS. 10-11C, a metal slab 300 may be rolled (either hot rolled or cold rolled) to a thickness that is close to the desired thickness with a series of dies 302. Each die 302 reduces the thickness of the slab, as shown in FIGS. 11A-C. A typical rolling process may involve, for example, sixteen (16) dies that are drive over the slab at sixteen (16) stations. The first fourteen dies 302 employed in the present method (only 3 are shown) are conventional dies with smooth outer surfaces and are used to bring the slab to a thickness that is close to its final thickness. The last two dies, which are identified by reference numeral 302′ (FIGS. 12A and 12B) and 302″ FIGS. 12D and 12E) are used to create the protrusions 104 and channels 108 and 110. More specifically, the corrugated die 302′ and its mirror image 302″ include respective series of protrusions 304′ and 304″ which form the channels 110 (FIG. 12C) and the channels 108 (FIG. 12F). The formation of the channels 108 and 110 also forms the protrusions 104. The result is a backing plate sheet 306, which includes the protrusions 104 and channels 108 and 110, that may then be used to form a plurality of the backing plates 100.

A plurality of the exemplary backing plates 100 may be formed from the backing plate sheet 306 by cutting portions out of the sheet that are in the shape of the backing plates. Stamping is one method of cutting portions out of the backing plate sheet 306. As illustrated for example in FIGS. 13A and 13B, the backing plate sheet 306 may be fed into a stamping machine 308, which stamps a plurality of backing plates 100 out of the backing plate sheet. The backing plate sheet 306 will include a number of holes 310 in the shape of the backing plates 100 after the stamping process. Other methods of forming the backing plates from the sheet 306 include laser cutting among other machining technologies.

There are a number of benefits associated with the present method of manufacturing brake pad backing plates. For example, conventional processes frequently involve rolling a slab into a smooth sheet, stamping parts out of the sheet, and then using a punching or gouging process to roughen the parts and complete backing plates. The present method eliminates the post-stamping punching or gouging steps by forming the protrusions 104 and channels 108 and 110 during the formation of the metal sheet from which the backing plates will ultimately be stamped. Not only is it easier to form protrusions or other discontinuities in one large sheet, as compared to a plurality of small parts, the present method forms the discontinuities as during steps in the rolling process that would have been performed anyway by simply replacing the conventional dies at the end of the rolling process with dies that will form discontinuities. As a result, the present method provides substantial cost savings as compared to conventional methods.

Although the present inventions have been described in terms of the preferred embodiments above, numerous modifications and/or additions to the above-described preferred embodiments would be readily apparent to one skilled in the art.

By way of example, but not limitation, the exemplary brake pad backing plate and brake pad illustrated in FIGS. 1-9 is well suited for automotive applications, other brake pad configurations, such as those employed in trains and other rail-based vehicles, planes, large trucks and construction vehicles and any other vehicle or apparatus in which brake pads are employed. The present method are also applicable to brake pads that include a wide variety of discontinuities in addition to the protrusion and channel arrangement described above. For example, punching or gouging processes may be performed on the sheet after the rolling process is completed, but prior to the stamping process. Although not as economical as the exemplary method illustrated in FIGS. 10-13B, such a method would still be more cost effective than performing the punching and gouging steps after stamping out the backing plated. The scope of the inventions also includes any combination of the elements from the various species and embodiments disclosed in the specification that are not already described.

It is intended that the scope of the present inventions extend to all such modifications and/or additions and that the scope of the present inventions is limited solely by the claims set forth below.

1. A method, comprising:
cutting a brake pad backing plate out of a sheet having a plurality of discontinuities formed therein.

2. A method as claimed in claim 1, wherein the step of cutting a brake pad backing plate out of a sheet comprises cutting a brake pad backing plate out of a sheet having a plurality of protrusions formed therein.

3. A method as claimed in claim 1, wherein the step of cutting a brake pad backing plate out of a sheet comprises cutting a brake pad backing plate out of a sheet having a plurality of channels formed therein.

4. A method as claimed in claim 1, wherein the step of cutting a brake pad backing plate out of a sheet comprises cutting a brake pad backing plate out of a sheet having respective pluralities of channels and protrusions formed therein.

5. A method as claimed in claim 1, further comprising the step of:
forming the discontinuities in the sheet during a sheet manufacturing process.

6. A method as claimed in claim 1, further comprising the step of:
forming the discontinuities in the sheet during a sheet rolling process.

7. A method as claimed in claim 1, wherein the step of cutting a brake pad backing plate out of a sheet comprises stamping a brake pad backing plate out of a sheet having a plurality of discontinuities formed therein.

8. A method of manufacturing a brake pad, comprising:
cutting a brake pad backing plate out of a sheet having a plurality of discontinuities formed therein; and
securing a friction pad to the brake pad backing plate.

9. A method as claimed in claim 8, wherein the step of cutting a brake pad backing plate out of a sheet comprises cutting a brake pad backing plate out of a sheet having a plurality of protrusions formed therein.

10. A method as claimed in claim 8, wherein the step of cutting a brake pad backing plate out of a sheet comprises cutting a brake pad backing plate out of a sheet having a plurality of channels formed therein.

11. A method as claimed in claim 8, wherein the step of cutting a brake pad backing plate out of a sheet comprises cutting a brake pad backing plate out of a sheet having respective pluralities of channels and protrusions formed therein.

12. A method as claimed in claim 8, further comprising the step of:
forming the discontinuities in the sheet during a sheet manufacturing process.

13. A method as claimed in claim 8, further comprising the step of:
forming the discontinuities in the sheet during a sheet rolling process.

14. A method as claimed in claim 8, wherein the step of securing a friction pad to the brake pad backing plate comprises molding the friction pad onto the brake pad backing plate such that a mechanical interconnect is created between the friction pad and the brake pad backing plate.

15. A method as claimed in claim 8, wherein the step of cutting a brake pad backing plate out of a sheet comprises stamping a brake pad backing plate out of a sheet having a plurality of discontinuities formed therein.

16. A brake pad backing plate, comprising:
a base member; and
a plurality of protrusions extending outwardly form from the base member, at least a portion of at least one of the protrusions defining a slanted parallelepiped shape.

17. A brake pad backing plate as claimed in claim 16, wherein at least a portion of each of the protrusions defines a slanted, parallelepiped shape.

18. A brake pad backing plate as claimed in claim 16, wherein less than all of the at least one protrusions defines a slanted, parallelepiped shape.

19. A brake pad backing plate as claimed in claim 16, wherein the protrusions are evenly spaced.

20. A brake pad backing plate as claimed in claim 16, wherein the slanted, parallelepiped shape slants in two directions.

21. A brake pad backing plate as claimed in claim 16, wherein the slanted, parallelepiped shape slants in two directions that are perpendicular to one another.

22. A brake pad backing plate as claimed in claim 16, wherein the base member defines a front surface and the protrusions extend outwardly from the front surface of the base member.

23. A brake pad backing plate as claimed in claim 16, wherein the base member front surface is substantially planar.

24. A brake pad, comprising:
a brake pad backing plate including a plurality of protrusions extending outwardly from the base member, at least a portion of at least one of the protrusions defining a slanted parallelepiped shape; and
a friction pad secured to brake pad by the plurality of protrusions.

25. A brake pad as claimed in claim 24, wherein at least a portion of each of the protrusions defines a slanted, parallelepiped shape.

26. A brake pad as claimed in claim 24, wherein less than all of the at least one protrusion defines a slanted, parallelepiped shape.

27. A brake pad as claimed in claim 24, wherein the protrusions are evenly spaced.

28. A brake pad as claimed in claim 24, wherein the slanted, parallelepiped shape slants in two directions.

29. A brake pad as claimed in claim 24, wherein the slanted, parallelepiped shape slants in two directions that are perpendicular to one another.

30. A brake pad as claimed in claim 24, wherein the base member defines a front surface and the protrusions extend outwardly from the front surface of the base member.

31. A brake pad as claimed in claim 24, wherein the base member front surface is substantially planar.
